(19) United States
(12) Patent Application Publication
(10) Pub. No.: US 2025/0292569 A1
(43) Pub. Date: Sep. 18, 2025

(54) APPARATUS FOR SKILL CONVERSION AND METHOD THEREOF

(71) Applicant: RESEARCH & BUSINESS FOUNDATION SUNGKYUNKWAN UNIVERSITY, Suwon-si (KR)

(72) Inventors: Hong Uk WOO, Suwon-si (KR); Sang Woo SHIN, Suwon-si (KR); Min Jong YOO, Suwon-si (KR)

(21) Appl. No.: 19/075,277

(22) Filed: Mar. 10, 2025

(30) Foreign Application Priority Data
Mar. 18, 2024 (KR) 10-2024-0036860

(51) Int. Cl. G06V 20/40; B25J 13/00; G06F 40/289; G06F 40/30

(52) U.S. Cl. CPC G06V 20/41; B25J 13/003; G06F 40/289; G06F 40/30

(57) ABSTRACT

A method for skill conversion comprises receiving a multi-modal form of prompt including at least one of video data, text data, or sensor data from a user, converting the prompt into a skill-level language instruction using an encoder corresponding to each of the multi-modal and generating a semantic skill sequence to be executed in a target domain based on the skill-level language instruction.

### CROSS-REFERENCE TO RELATED APPLICATION

This application claims the priority benefit of Korean Patent Application No. 10-2024-0036860 filed on Mar. 18, 2024, in the Korean Intellectual Property Office, the disclosures of which are incorporated herein by reference.

### BACKGROUND

### 1. Field

The present invention relates to an apparatus for skill conversion and a method thereof.

### 2. Description of the Related Art

In general, cross-domain zero shot adaptation makes it possible to adapt immediately without additional data collection or interaction with the environment in the new domain, utilizing knowledge built in the learning domain.

However, cross-domain zero-shot adaptation has high practicality in the field of autonomous driving or robotics, where a single failure can incur a large cost. At the same time, however, it is difficult to achieve due to the complexity of tasks and the dynamic nature of the environment inherent in the domain.

On the other hand, there are three techniques based on Decision Transformer that directly prompt expert data as a method of adapting an agent in a new domain using knowledge built in the learning process. The first technique considers a cross domain in which tasks to be performed are changed, and the second technique considers a cross domain in which only environmental factors are changed when the tasks are the same.

However, since the first technique and the second technique directly require expert data of the target domain at the time of zero shot adaptation, there is a limitation in that the applicable real-world situation is limited.

In addition, the third technique considers both tasks and environmental factors, and has a problem in that it can handle only short and simple tasks.

### SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

The present invention is directed to an apparatus and a method for skill conversion for embedding a prompt using an encoder suitable for each modality, and converting a semantic skill array executed in a target domain based on the embedded prompt.

To solve the aforementioned problem, a skill transformation apparatus and method are provided.

A method for skill conversion comprises receiving a multi-modal form of prompt including at least one of video data, text data, or sensor data from a user, converting the prompt into a skill-level language instruction using an encoder corresponding to each of the multi-modal and generating a semantic skill sequence to be executed in a target domain based on the skill-level language instruction.

In one embodiment, when the prompt is video data including a plurality of frames, the encoder is implemented as a vision encoder of a vision-language model.

In one embodiment, when the prompt is sensor data composed of an arrangement of state-action pairs having a reference length, the encoder is implemented by learning a classifier for predicting a semantic skill expressed by the arrangement of state-action pairs.

In one embodiment, when the prompt is text data, the encoder is implemented as an identity function.

In one embodiment, a method for skill conversion further comprises calculating a probability of performing a next skill based on the semantic skill sequence.

In one embodiment, the calculating a probability of performing a next skill comprises calculating the probability that the next skill needs to be performed based on a current state, a semantic skill being executed at a current time point t, and a state at a moment when the semantic skill sequence is first executed

In one embodiment, a method for skill conversion further comprises generating an executable skill sequence based on the skill-level language instruction and the semantic skill sequence.

In one embodiment, the executable skill sequence is comprised of a semantic skill, a domain element, and a magnitude.

In one embodiment, a method for skill conversion further comprises generating an action to be executed in the target domain based on the executable skill sequence and the current state.

In one embodiment, the generating an action to be executed in the target domain comprises inferring a hidden context of an environment by inputting a history to an online domain information encoder and generating the action by combining the hidden context and the executable skill sequence.

An apparatus for skill conversion comprises a receiver configured to receive a multi-modal form of prompt including at least one of video data, text data, or sensor data from a user and a processor comprising a language converter configured to convert the prompt into a skill-level language instruction using an encoder corresponding to each of the multi-modal and an array generator configured to generate a semantic skill sequence to be executed in a target domain based on the skill-level language instruction.

In one embodiment, when the prompt is video data including a plurality of frames, the encoder is implemented as a vision encoder of a vision-language model.

In one embodiment, when the prompt is sensor data composed of an arrangement of state-action pairs having a reference length, the encoder is implemented by learning a classifier for predicting a semantic skill expressed by the arrangement of state-action pair.

In one embodiment, when the prompt is text data, the encoder is implemented as an identity function.

In one embodiment, the array generator further comprises probability calculator configured to calculate a probability of performing a next skill based on the semantic skill sequence.

In one embodiment, the probability calculator is further configured to calculate the probability that the next skill needs to be performed based on a current state, a semantic skill being executed at a current time point t, and a state at a moment when the semantic skill sequence is first executed.

In one embodiment, the processor further comprises skill adapter configured to generate an executable skill sequence based on the skill-level language instruction and the semantic skill sequence.

In one embodiment, the executable skill sequence is composed of a semantic skill, a domain element, and a magnitude.

In one embodiment, the skill adapter is configured to generate an action to be executed in the target domain based on the executable skill sequence and the current state.

In one embodiment, the skill adapter is configured to infer a hidden context of an environment by inputting a history to an online domain information encoder and generate the behavior by combining the hidden context and the executable skill sequence.

According to the above-described apparatus for skill conversion and method thereof, it is possible to understand prompts of a user expressed in various modalities, solve a problem of performance degradation that occurs when an agent is executed in a new domain that is not seen in a learning process, and efficiently solve requirements of a real-world artificial intelligence model that should be executed in various environments and domains.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram for describing a configuration of an apparatus for skill conversion according to an embodiment of the present disclosure.

FIG. 2 is a diagram for describing a prompt according to an embodiment of the present disclosure.

FIG. 3 is a diagram for describing embedding according to an embodiment of the present disclosure.

FIG. 4 is a diagram for describing generation of a skill-level language instruction according to an embodiment of the present disclosure.

FIG. 5 is a diagram for describing generation of an array according to an embodiment of the present disclosure.

FIG. 6 is a diagram for describing a skill adapter according to an embodiment of the present disclosure.

FIG. 7 is a flowchart illustrating a method for skill conversion according to an embodiment of the present disclosure.

FIG. 8 is a diagram for describing a cross-domain zero shot adaptation performance according to an embodiment of the present disclosure.

FIG. 9 is a diagram for describing a task-level cross-domain zero shot adaptation performance according to an embodiment of the present disclosure.

FIG. 10 is a diagram for describing a skill-level cross-domain zero shot adaptation performance according to an embodiment of the present disclosure.

FIG. 11 is a diagram for describing a cognitive robot controller according to an embodiment of the present disclosure.

FIG. 12 is a diagram for describing an autonomous driving simulation according to an embodiment of the present disclosure.

Throughout the drawings and the detailed description, the same reference numerals may refer to the same, or like, elements. The drawings may not be to scale, and the relative size, proportions, and depiction of elements in the drawings may be exaggerated for clarity, illustration, and convenience.

### DETAILED DESCRIPTION

The advantages and features of the present invention, as well as methods for achieving them, will become apparent by referring to the embodiments described below in conjunction with the accompanying drawings. However, the present invention is not limited to the embodiments disclosed herein and may be implemented in various different forms. The embodiments are provided merely to ensure a complete disclosure of the invention and to fully convey the scope of the invention to those skilled in the art. The present invention shall be defined solely by the scope of the claims.

A brief explanation of the terms used in this specification will be provided, followed by a detailed description of the present invention.

The terms used in the present invention have been selected, to the extent possible, as generally used terms that are widely accepted in the relevant technical field, considering the functions of the invention. However, the meanings of the terms may vary depending on the intent of those skilled in the art, legal precedents, or the emergence of new technologies. In certain cases, terms arbitrarily defined by the applicant may be used, and in such cases, the meanings of these terms will be explicitly described in the detailed description of the invention. Therefore, the terms used in the present invention should not be construed as mere labels but should be interpreted based on their meanings and the overall disclosure of the present invention.

Throughout the specification, when an element is described as “including” another element, it should be understood, unless otherwise explicitly stated, that additional elements may be included rather than excluding other elements. Furthermore, the terms such as “unit,” “module,” and “portion” as used in this specification refer to components that process at least one function or operation and may be implemented as hardware components such as software, an FPGA, or an ASIC, or a combination of software and hardware. However, the terms “unit,” “module,” and “portion” are not necessarily limited to software or hardware. These terms may be configured to exist in an addressable storage medium and may also be configured to be executable by one or more processors. For example, the terms “unit,” “module,” and “portion” may encompass software components, object-oriented software components, class components, task components, as well as processes, functions, properties, procedures, subroutines, program code segments, drivers, firmware, microcode, circuits, data, databases, data structures, tables, arrays, and variables.

Hereinafter, embodiments of the present invention will be described in detail with reference to the accompanying drawings to enable those skilled in the art to readily implement the invention. In the drawings, elements that are not directly related to the description of the invention are omitted to enhance clarity.

Terms such as “first,” “second,” etc., used to describe various components, may be employed merely for distinguishing different elements, and such terms do not limit the elements. For example, within the scope of the present invention, a “first” component may be referred to as a “second” component, and similarly, a “second” component may be referred to as a “first” component. The term “and/or” includes a combination of multiple related elements as well as any one of those multiple related elements.

Hereinafter, it is a diagram for describing an apparatus for skill conversion according to an embodiment of the present invention with reference to the drawings.

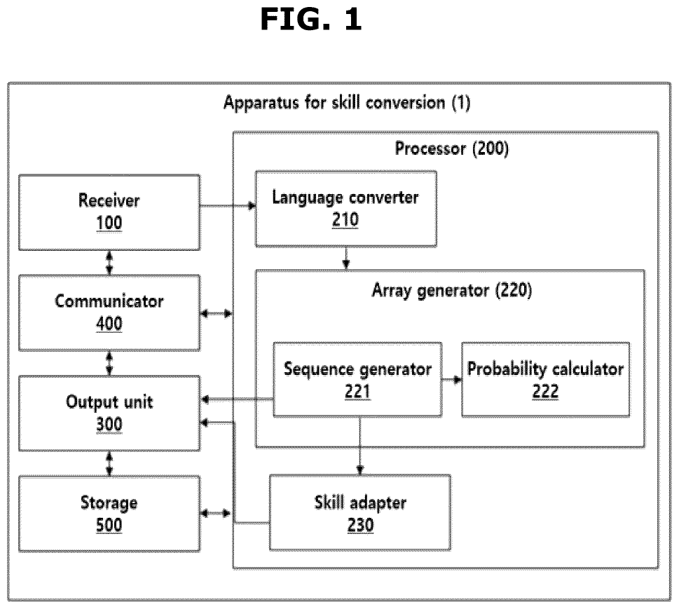

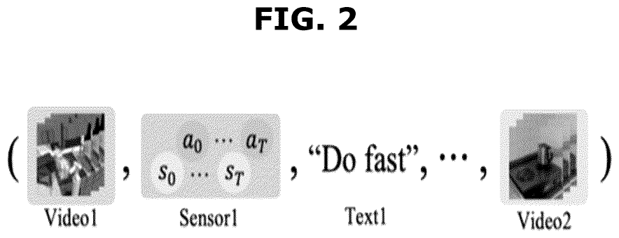

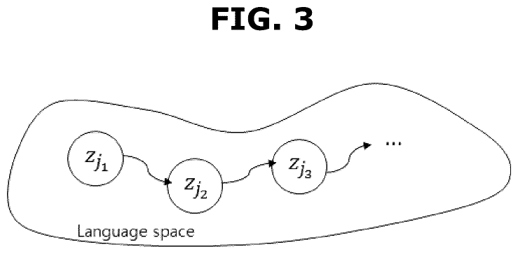

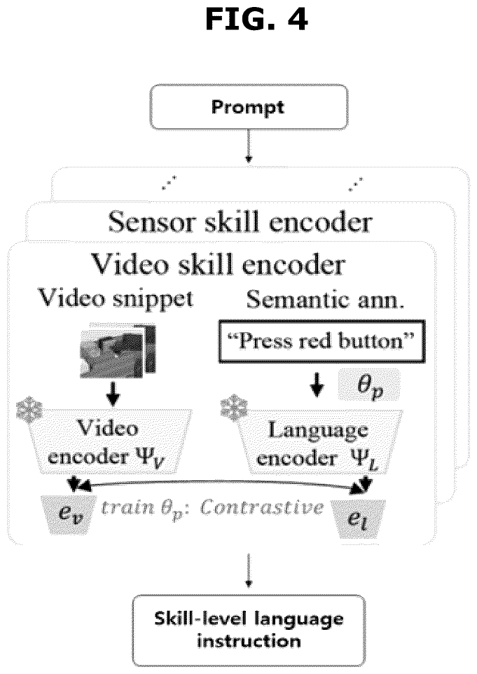

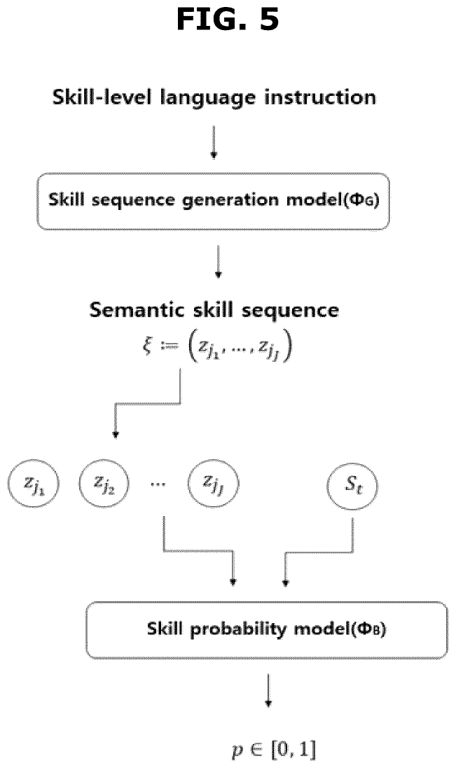

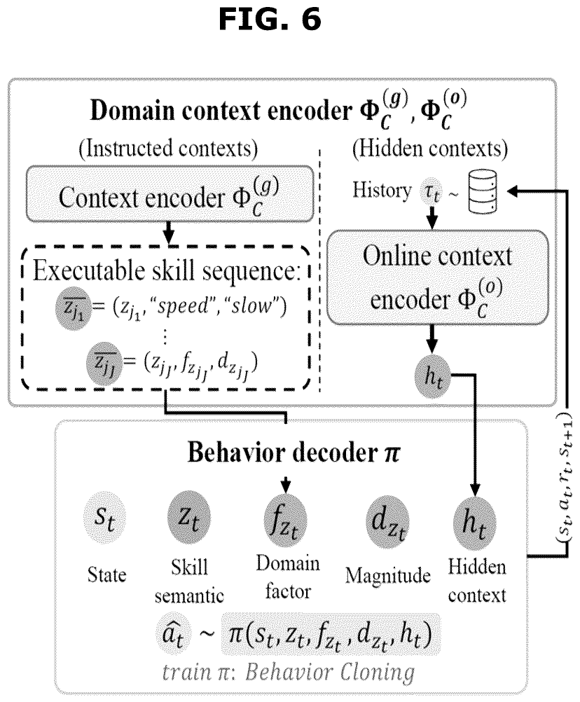

FIG. 1 is a block diagram for describing a configuration of an apparatus for skill conversion according to an embodiment of the present disclosure, FIG. 2 is a diagram for describing a prompt according to an embodiment of the present disclosure, FIG. 3 is a diagram for describing embedding according to an embodiment of the present disclosure, FIG. 4 is a diagram for describing generation of a skill-level language instruction according to an embodiment of the present disclosure, FIG. 5 is a diagram for describing generation of an array according to an embodiment of the present disclosure, and FIG. 6 is a diagram for describing a skill adapter according to an embodiment of the present disclosure.

As illustrated in FIG. 1, an apparatus for skill conversion 1 includes a receiver 100, a processor 200, an output unit 300, a communicator 400, and a storage 500.

The communicator 400 may allow the receiver 100, the processor 200, the output unit 300, and the storage 500 to transmit and receive data to and from each other.

For example, the communicator 400 may be implemented using at least one communication module (e.g., a LAN card, a short-range communication module, or a mobile communication module).

The communicator 400 includes both wired and wireless communication networks. For example, a wired/wireless Internet network may be used or linked as the communicator 400. Here, the wired Internet network includes an Internet network such as a cable network or a public telephone network (PSTN), and the wireless Internet network includes CDMA, WCDMA, GSM, Evolved Packet Core (EPC), Long Term Evolution (LTE), a Wibro network, a 5G communication network, and the like. Of course, the communicator 400 according to an embodiment of the present disclosure is not limited thereto, and may be used as an access network of a next-generation mobile communication system to be implemented in the future, for example, a cloud computing network under a cloud computing environment, a 5G network, or the like. For example, when the communicator 400 is a wired communication network, an access point in the communication network may access an exchange station of a telephone station, and the like, but when the communicator is a wireless communication network, the access point may access an SGSN or a Gateway GPRS Support Node (GGSN) operated by a communication company to process data, or may access various repeaters such as Base Station Transmission (BTS), NodeB, e-NodeB, and the like to process data.

The storage 500 may store prompts, semantic skill sequences, executable skill sequences, and actions to be executed.

The storage 500 may store a probability of performing the next skill.

The storage 500 may include at least one of a main memory device and an auxiliary memory device. The main memory device may be implemented using a semiconductor storage medium such as, for example, ROM and/or RAM, and the auxiliary memory device may be implemented based on a device capable of permanently or semi-permanently storing data, such as a flash memory device (a Solid State Drive (SSD)), a Secure Digital (SD) card, a Hard Disc Drive (HDD), a compact disk, a Digital Versatile Disk (DVD), a laser disk, or the like.

The receiver 100 receives a multi-modal prompt from a user.

As shown in FIG. 2, the prompt may include at least one of video data, text data, and sensor data, or may include a combination of video data, text data, and sensor data.

The prompt may be composed of snippets x₁ that are helpful for adaptation in the new domain.

The snippet may be represented as video data, text data, or sensor data.

For example, the snippet may be “do fast” and may include information that the agent's task performance should end within a certain time.

As such, the snippet may include information about the action.

The receiver 100 may receive the prompt as shown in Equation 1 below.

$$P = ( {x}_{1} , … , {x}_{N} ) \qquad [ Equation 1 ]$$

Here, P is the prompt, and x₁, . . . , x_{N} represent the snippets.

The processor 200 may include a language converter 210, an array generator 220, and a skill adapter 230.

The language converter 210 converts the prompt into a skill-level language instruction using each encoder corresponding to the multi-modal.

The language converter 210 may input the snippet of the prompt to the skill encoder ΦE and embed the snippet into the language space.

Here, the language space may be an embedding space of a pre-trained language model.

As shown in FIG. 3, the language converter 210 may embed a user's prompt into a language space through task adaptation and convert the user's prompt into a skill-level language instruction.

As illustrated in FIG. 4, in an embodiment, when the snippet of the prompt is video data (xᵢ=v_{1:t}) including a plurality of frames T, the skill encoder Φ_{E} may be implemented as a vision encoder ψ_{V} of a trained vision-language model.

Language converter 210 may be finely adjusted using contrastive learning through prompts.

The language converter 210 may learn the objective function using Equation 2.

$$L ( {Ψ}_{V} ) = log \frac{S ( {Ψ}_{V} ( {v}_{t : t + H} ) , {Ψ}_{L} ( {l}_{t} ; {θ}_{p} )}{{\sum }_{{l}_{t} \neq l ∈ L} S ( {Ψ}_{V} ( {v}_{t : t + H} ) , {Ψ}_{L} ( l , {θ}_{p} ) )} \qquad [ Equation 2 ]$$

Here, L(Ψ_{V}) is an objective function for a vision encoder of a vision-language model, Ψ_{V} is a vision encoder of the vision-language model, lₜ is a linguistic representation of a skill represented by the video data v_{1:t}, θₚ is a parameter of a prompt, Ψ_{L} is a language encoder of the vision-language model, S is a cosine similarity measurement function, V_{t:t+H} are t˜t+H frames of the video, Lt is a language representing V_{t:t+H}, L is a set of all languages representing the video, and l represents an element of the set L.

For example, L; may represent a language representing a video of V_{t:t+H} such as “catch a ball”, and L may be a set of all languages representing videos such as “catch a ball”, “open a refrigerator door”, “close a drawer”, and the like.

In other words, L may be a set of languages representing an operation included in a video, and Lₜ may represent a language representing an operation included in a video.

In another embodiment, when the snippet of the prompt is sensor data composed of an arrangement of state-action pairs xᵢ=s_{t-H:t}, a_{t-H:t} having a reference length H, the language converter 210 may be implemented by learning a classifier that inputs the arrangement of state-action pairs xᵢ=s_{t-H:t}, a_{t-H:t} to a skill encoder Φ_{E} to predict a semantic skill lₜ expressed by the sequence.

Here, the semantic skill represents a short action unit that the agent may perform, and may include, for example, an operation expression such as “catch the ball”.

In other words, the language converter 210 may input the arrangement of the state-action pairs to the skill encoder to train the classifier that infers an operation expression that is a semantic skill.

In another embodiment, when the snippet of the prompt is the text data (xᵢ=lᵢ), the language converter 210 may convert the prompt into a skill-level language instruction (linguistic prompt) as shown in Equation 3 below such that the prompt is input to the skill encoder Φ_{E} to be expressed in a linguistic form.

$$P = ( {x}_{1} , … , {x}_{N} ) \to η := ( {l}_{{i}_{1}}^{src} , … , {l}_{{i}_{l}}^{src} ) \qquad [ Equation 3 ]$$

Here, P is the prompt, x₁, . . . , x_{N} are the snippets, lᵢₗ^{src} is the language token, and n is the skill level language indication, which represents the linguistic expressed prompt.

The skill-level language instruction may be a form in which a multi-modal prompt of a user is expressed in a linguistic form, for example, a form in which a continuous operation such as ‘Catch a ball. Then put the ball in the drawer . . . ’ is expressed in a linguistic form.

The skill encoder Φ_{E} may be implemented as an identity function to preserve text as it is.

As described above, the language converter 210 may embed the prompt and convert the embedded prompt into a skill-level language instruction.

For example, the first skill-level language instruction lᵢ₁^{src} may be “Imitate”, the second skill-level language instruction lᵢ₂^{src} may be “press red button”, the third skill-level language instruction lᵢ₃^{src} may be “open drawer”, and the fourth skill-level language instruction lᵢ₄^{src} may be “slow”.

The array generator 220 generates a semantic skill sequence on the basis of the skill-level language instruction converted from the language converter 210.

The array generator 220 may generate a semantic skill sequence by using the skill decoder Φ_{D}.

The array generator 220 may generate a semantic skill sequence through task-level adaptation.

The array generator 220 may include a sequence generator 221 and a probability calculator 222.

The sequence generator 221 may generate a semantic skill sequence to be executed in the target domain based on the skill-level language instruction η.

Here, the sequence generator 221 may generate a semantic skill sequence by inputting the skill-level language instruction η to the skill sequence generation model Φ_{G}.

The skill sequence generation model Φ_{G} may be implemented as a pre-trained transformer-based language model, and may be included in the skill decoder Φ_{D}.

The skill sequence generation model Φ_{G} may be implemented as a generative artificial intelligence model such as GPT.

The skill sequence generation model Φ_{G} may be trained through a cross entropy loss function while performing sequence to sequence.

The sequence generator 221 may represent a semantic skill sequence to be executed in the target domain by Equation 4 below.

$${Φ}_{c} : η \to ξ := ( {z}_{{j}_{1}} , … , {z}_{{j}_{J}} ) \qquad [ Equation 4 ]$$

Here, Φ_{G} is a skill sequence generation model, η is a skill-level language instruction, z_{jJ} is a semantic skill, and ξ represents a semantic skill sequence.

For example, in the semantic skill sequence, the first semantic skill zⱼ₁ may be “press blue switch”, and the second semantic skill zⱼ₂ may be “open drawer”

The probability calculator 222 calculates a probability that the next skill should be performed based on the semantic skill sequence.

The probability calculator 222 may calculate a probability that the next skill needs to be performed using each of the first semantic skill to the J-th semantic skill.

Specifically, the probability calculator 222 may input the current state Sₜ, the semantic skill zₜ=zⱼ₁, . . . , z_{jJ} being executed at the current time point t, and the state Sₜ₀ at the moment when the semantic skill sequence is first implemented into the skill probability model Φ_{B}, and represent the probability that the next skill should be performed as in Equation 5 below.

$$( {s}_{t} , {z}_{t} , {s}_{{t}_{a}} ) \to p ∈ [ 0 , 1 ] \qquad [ Equation 5 ]$$

Here, Sₜ is a current state, zₜ is a semantic skill currently being executed at time t, Sₜ₀ is a state at the moment when the semantic skill sequence was first implemented, and p represents a probability.

In other words, with respect to the semantic skill sequence inferred by Equation 4, when there is a high probability that the next skill calculated by the probability calculator 222 needs to be performed, the skill adapter 230 may allow the skill (action) to be executed to be executed correctly.

The skill probability model Φ_{B} may be learned through a binary cross-entropy loss function.

The skill probability model Φ_{B} may be included in a skill decoder Φ_{D}.

The skill adapter 230 generates an executable skill sequence z̅_̅{̅J̅1̅}̅, . . . , z̅_̅{̅J̅j̅}̅ based on the skill-level language instruction η and the semantic skill sequence ξ.

Specifically, as illustrated in FIG. 6, the skill adapter 230 may input the skill-level language instruction η and the semantic skill sequence ξ to the domain information encoder Φ_{C}^{(g)} to generate the executable skill sequence z̅_̅{̅J̅1̅}̅, . . . , z̅_̅{̅J̅j̅}̅.

The domain information encoder Φ_{C}^{(g)} may be implemented as a generative artificial intelligence model such as a GPT.

Here, the skill adapter 230 may allow the semantic skill sequence ξ generated through the task-level adaptation to be correctly executed in the target domain.

The executable skill sequence Z̅=(z, f_{z}, d_{z}) may be composed of a semantic skill z, a domain element f_{z}, and a magnitude d_{z}.

For example, the semantic skill may be “moving to a specific destination”, the domain element f_{z} corresponding to “moving to a specific destination” may be “speed” requested by the user, and the magnitude d_{z} may be a “speed” value.

The skill adapter 230 generates an action at to be executed in the target domain based on the generated executable skill sequence and the current state Sₜ.

The skill adapter 230 may input the executable skill z̅ₜ̅, which is at least one of the generated executable skill sequence, and the current state Sₜ to the action decoder π, and generate an action at to be executed in the target domain.

Here, the current state may include at least one of image information by the robot camera and sensor information by the sensor recognizer.

The behavior decoder π may be implemented as a generative artificial intelligence model such as GPT.

Here, the skill adapter 230 may input the history τₜ into the online domain information encoder Φ_{C}^{(g)} in consideration of domain information that the user may not include in the prompt, and infer the hidden context hₜ of the environment, and the hidden context hₜ may be combined with the executable skill zₜ.

Here, the history may include a state-action sequence created by interacting with the environment.

The skill adapter 230 may generate an action at to be executed in the target domain by combining the hidden context hₜ and the executable skill z̅ₜ̅.

The online domain information encoder Φ_{C}^{(o)} may be trained through contrast learning or reconstruction.

In this way, the skill adapter 230 may allow the semantic skill sequence obtained through the task-level adaptation to be correctly executed in the target domain.

The output unit 300 may store the prompt received from the user.

The output unit 300 may store the generated semantic skill sequence, the executable skill sequence, and the actions to be executed in the target domain.

The output unit 300 may store a probability of performing the next skill after being calculated.

The output unit 300 may include, for example, a display, a printer device, a speaker device, an image output terminal, a data input/output terminal, or a communication module, but is not limited thereto.

If necessary, the output unit 300 may be provided integrally with the receiver 100.

Hereinafter, a method for skill conversion according to an embodiment of the present invention will be described with reference to the drawings.

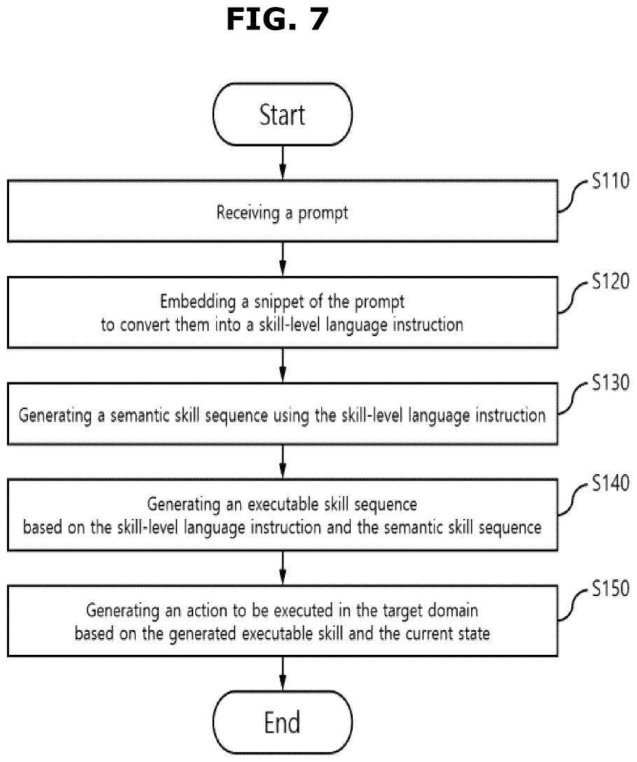

FIG. 7 is a flowchart illustrating a method for skill conversion according to an embodiment of the present disclosure.

The receiver 100 receives a prompt from a user (S110).

The prompt is a multi-modal form, and may include at least one of video data, text data, and sensor data, or may include a combination of video data, text data, and sensor data. The prompt may consist of a plurality of snippets.

The language converter 210 embeds a snippet of the prompt into a linguistic space to convert the snippet into a skill-level language instruction (S120).

The language converter 210 may input a snippet of a prompt to a skill encoder Φ_{E} in response to the multi-modal to convert the prompt into a skill-level language instruction.

In an embodiment, when the snippet is video data xᵢ=v_{1:t} including a plurality of frames T, the skill encoder Φ_{E} may be implemented as a vision encoder ψ_{V} of a trained vision-language model.

In another embodiment, when the snippet is sensor data composed of an arrangement of state-action pairs xᵢ=s_{t-H:t}, a_{t-H:t} having a reference length, the language converter 210 may be implemented by learning a classifier that inputs the arrangement of state-action pairs xᵢ=s_{t-H:1}, a_{t-H:1} to the skill encoder Φ_{E} to predict a semantic skill lₜ expressed by the sequence.

In another embodiment, when the snippet is text data x=lᵢ, the language converter 210 may input a prompt to a skill encoder Φ_{E} and express the prompt in a language.

As described above, the language converter 210 may generate a skill-level language instruction by inputting a snippet of the prompt to each encoder according to the multi-modal.

The array generator 220 generates a semantic skill sequence using the skill-level language instruction (S130).

The sequence generator 221 may generate a semantic skill sequence to be executed in the target domain by inputting the skill-level language instruction n to the skill sequence generation model Φ_{G}.

Here, the probability calculator 222 may input the current state Sₜ, the semantic skill zₜ=zⱼ₁, . . . , z_{jJ} that is being executed at the current time t, and the state Sₜ₀ at the moment when the semantic skill sequence is first implemented to the skill probability model Φ_{B} to calculate the probability that the next skill should be performed.

The skill adapter 230 generates the executable skill sequence z̅ⱼ̅_̅{̅₁̅}̅, . . . , z̅ⱼ̅_̅{̅_̅{̅J̅}̅}̅, based on the skill-level language instruction η and the semantic skill sequence ξ (S140).

The skill adapter 230 may generate the executable skill sequence z̅ⱼ̅_̅{̅₁̅}̅, . . . , z̅ⱼ̅_̅{̅_̅{̅J̅}̅}̅ by inputting the skill-level language instruction η and the semantic skill sequence ξ to a domain information encoder Φ_{C}^{(g)}.

The skill adapter 230 may allow the semantic skill sequence ξ generated through the task-level adaptation to be executed correctly in the target domain.

The skill adapter 230 generates an action to be executed in the target domain at based on the generated executable skill z̅ₜ̅ and the current state Sₜ (S150).

The skill adapter 230 may input the executable skill z̅ₜ̅ and the current state Sₜ to the action decoder π to generate an action aₜ to be executed in the target domain.

Here, the skill adapter 230 may infer a hidden context hₜ of the environment by using the online domain information encoder Φ_{C}^{(o)} in consideration of domain information that the user cannot include in the prompt, and the hidden context hₜ may be combined with the executable skill z̅ₜ̅.

In this way, the skill adapter 230 may allow the semantic skill sequence obtained through the task-level adaptation to be correctly executed in the target domain.

Hereinafter, the performance of an apparatus for skill conversion according to an embodiment of the present invention will be described with reference to the drawings.

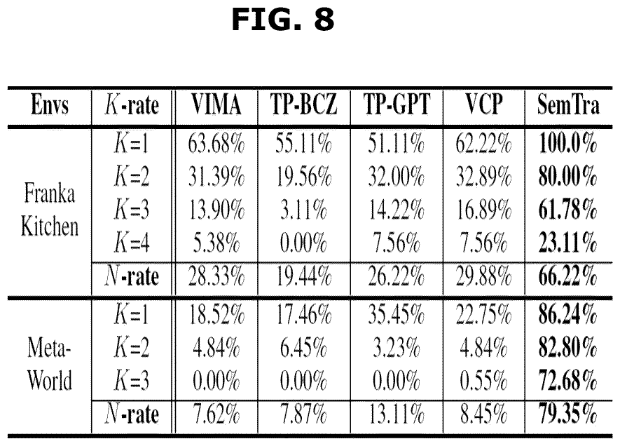

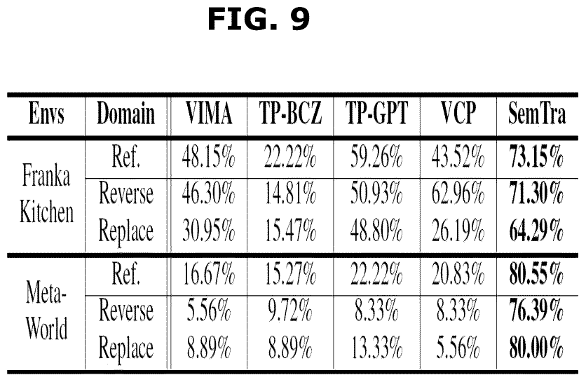

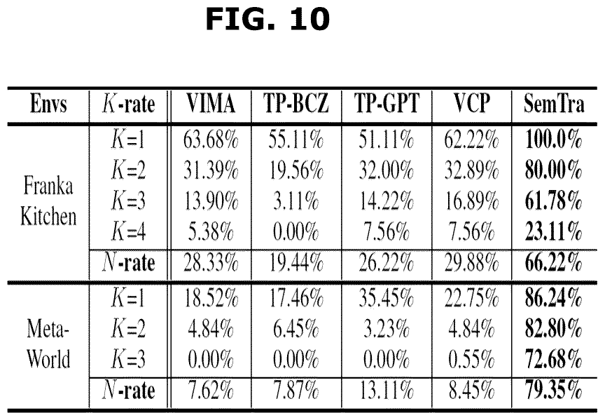

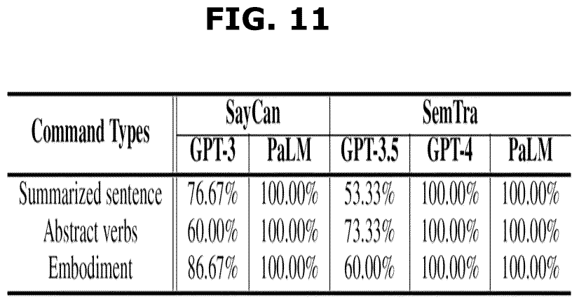

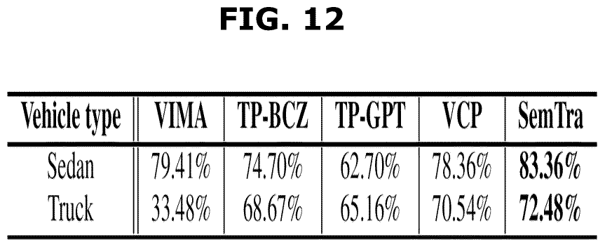

FIG. 8 is a diagram for describing a cross-domain zero shot adaptation performance according to an embodiment of the present invention, FIG. 9 is a diagram for describing a task-level cross-domain zero shot adaptation performance according to an embodiment of the present invention, FIG. 10 is a diagram for describing a skill-level cross-domain zero shot adaptation performance according to an embodiment of the present invention, FIG. 11 is a diagram for describing a cognitive robot controller according to an embodiment of the present invention, and FIG. 12 is a diagram for describing an autonomous driving simulation according to an embodiment of the present invention.

In order to evaluate the performance of the present invention, experiments were performed in a robot arm environment multi-stage Meta-world and a Franka Kitchen simulation environment, and in addition, in order to evaluate the applicability of the present invention to real-world problems, a robot arm environment RLBench and an autonomous driving simulation environment CARLA were used.

For performance comparison in the corresponding environment, VIMA, which is a conventional Cross-Attention-based methodology capable of receiving a multi-modal prompt of a user, TP-GPT, which is a Self-Attention-based methodology, TP-BCz, which is a zero-shot imitation learning framework, and VCP, which is a task prompting methodology based on video generation, were used.

FIG. 8 shows a task success rate when a user commands a new task to an agent through a multi-modal prompt, and as shown in FIG. 8, it is an experiment to show that the method for skill conversion SemTra according to an embodiment of the present disclosure improves learning performance compared to other comparison groups, and it can be seen that the method for skill conversion according to an embodiment of the present disclosure shows 36.34% and 66.24% higher performance in Meta-World and Franka Kitchen, respectively, compared to VCP and TP-GPT, which are the most powerful comparison groups.

FIG. 9 illustrates an experimental result for a case in which only a task-level domain difference exists, and a skill-level domain difference does not exist.

For example, a case where a domain difference of a task-level exists indicates a case where a snippet such as “in reverse order” is added to a user prompt and a task needs to be performed in an opposite order, and a case where a domain difference of a skill-level does not exist indicates a case where an agent only needs to complete a task and there is no domain difference for a speed limit.

As shown in FIG. 9, it can be seen that the performance of the comparison group TP-GPT is decreased by 9.39% compared to the single domain performance Ref having no domain difference, but the method for skill conversion according to an embodiment of the present disclosure shows only a performance decrease of 7.08%.

FIG. 10 illustrates an experimental result for a case in which only a domain difference of a skill-level exists and a domain difference of a task-level does not exist.

For example, when there is a domain difference of a skill-level, a snippet such as “do fast” is added to a user prompt and a corresponding task needs to be quickly performed, and when there is no domain difference of a task-level, it is necessary to execute the skills contained in the user prompt in order.

As shown in FIG. 10, it can be seen that the method for skill conversion according to an embodiment of the present disclosure shows 39.35% and 65.73% higher performance in Meta-World and Franka Kitchen, respectively, compared to the most powerful comparison groups TP-BCz and TP-GPT.

FIG. 11 shows that, when a user's command is given in an abstract language, a correct skill sequence may be predicted when a skill sequence generation model Φ_{G} according to an embodiment of the present disclosure is implemented with a latest language model.

As shown in FIG. 11, it can be seen that, if the skill sequence generation model Φ_{G} according to an embodiment of the present invention is replaced with a language model that is currently continuously developing, problems of more complex and various situations can be solved.

As shown in FIG. 12, an autonomous driving simulation CARLA was used to measure the adaptability of the skill-level of the present invention.

For example, two skill-level domains “truck” or “sedan” have been defined, and the agent should move the shortest distance from the start point to the destination point according to the user's command. In this environment, it can be seen that the skill conversion method according to an embodiment of the present disclosure shows performance improved by 1.94 to 5.00% compared to the most powerful comparison group VCP.

As described above, according to the present disclosure, it is possible to understand prompts of a user expressed in various modalities, solve a problem of performance degradation that occurs when an agent is executed in a new domain that is not seen in a learning process, and efficiently solve requirements of a real-world artificial intelligence model that should be executed in various environments and domains.

It will be understood by those skilled in the art related to the embodiments of the present invention that modifications can be made without departing from the essential characteristics of the disclosed invention. Therefore, the disclosed methods should be regarded as illustrative rather than restrictive. The scope of the present invention is defined by the claims rather than the detailed description, and all variations within an equivalent scope shall be interpreted as being included within the scope of the present invention.

What is claimed is:

1. A method for skill conversion comprising:
receiving a multi-modal form of prompt including at least one of video data, text data, or sensor data from a user;
converting the prompt into a skill-level language instruction using an encoder corresponding to each of the multi-modal; and
generating a semantic skill sequence to be executed in a target domain based on the skill-level language instruction.

2. The method for skill conversion of claim 1,
wherein when the prompt is video data including a plurality of frames, the encoder is implemented as a vision encoder of a vision-language model.

3. The method for skill conversion of claim 1,
wherein when the prompt is sensor data composed of an arrangement of state-action pairs having a reference length, the encoder is implemented by learning a classifier for predicting a semantic skill expressed by the arrangement of state-action pairs.

4. The method for skill conversion of claim 1,
wherein when the prompt is text data, the encoder is implemented as an identity function.

5. The method for skill conversion of claim 1, further comprising:
calculating a probability of performing a next skill based on the semantic skill sequence.

6. The method for skill conversion of claim 5,
wherein the calculating a probability of performing a next skill comprises calculating the probability that the next skill needs to be performed based on a current state, a semantic skill being executed at a current time point t, and a state at a moment when the semantic skill sequence is first executed.

7. The method for skill conversion of claim 1, further comprising:
generating an executable skill sequence based on the skill-level language instruction and the semantic skill sequence.

8. The method for skill conversion of claim 7,
wherein the executable skill sequence is comprised of a semantic skill, a domain element, and a magnitude.

9. The method for skill conversion of claim 7, further comprising:
generating an action to be executed in the target domain based on the executable skill sequence and the current state.

10. The method for skill conversion according to claim 9,
wherein the generating an action to be executed in the target domain comprises:
inferring a hidden context of an environment by inputting a history to an online domain information encoder; and
generating the action by combining the hidden context and the executable skill sequence.

11. An apparatus for skill conversion comprising:
a receiver configured to receive a multi-modal form of prompt including at least one of video data, text data, or sensor data from a user; and
a processor; comprising:
a language converter configured to convert the prompt into a skill-level language instruction using an encoder corresponding to each of the multi-modal and
an array generator configured to generate a semantic skill sequence to be executed in a target domain based on the skill-level language instruction.

12. The apparatus for skill conversion of claim 11,
wherein when the prompt is video data including a plurality of frames, the encoder is implemented as a vision encoder of a vision-language model.

13. The apparatus for skill conversion of claim 11,
wherein when the prompt is sensor data composed of an arrangement of state-action pairs having a reference length, the encoder is implemented by learning a classifier for predicting a semantic skill expressed by the arrangement of state-action pair.

14. The apparatus for skill conversion of claim 11,
wherein when the prompt is text data, the encoder is implemented as an identity function.

15. The apparatus for skill conversion of claim 11,
wherein the array generator further comprises:
probability calculator configured to calculate a probability of performing a next skill based on the semantic skill sequence.

16. The apparatus for skill conversion of claim 15,
wherein the probability calculator is further configured to calculate the probability that the next skill needs to be performed based on a current state, a semantic skill being executed at a current time point t, and a state at a moment when the semantic skill sequence is first executed.

17. The apparatus for skill conversion of claim 11,
wherein the processor further comprises:
skill adapter configured to generate an executable skill sequence based on the skill-level language instruction and the semantic skill sequence.

18. The apparatus for skill conversion of claim 17,
wherein the executable skill sequence is composed of a semantic skill, a domain element, and a magnitude.

19. The apparatus for skill conversion of claim 17,
wherein the skill adapter is configured to generate an action to be executed in the target domain based on the executable skill sequence and the current state.

20. The apparatus for skill conversion of claim 19,
wherein the skill adapter is configured to infer a hidden context of an environment by inputting a history to an online domain information encoder and generate the behavior by combining the hidden context and the executable skill sequence.
